(19) United States
(12) Patent Application Publication
(10) Pub. No.: US 2010/0097415 A1
(43) Pub. Date: Apr. 22, 2010

(54) PRODUCING AND DEFLECTING INK DROPLETS OF VARIABLE SIZE

(76) Inventors: Klaus PECHTL, Stadtschwarzach (DE); Peter Schmitt, Wurzburg (DE)

Correspondence Address: K.F. ROSS P.C., 5683 RIVERDALE AVENUE, SUITE 203 BOX 900, BRONX, NY, 10471-0900, US

(21) Appl. No.: 12/166,829

(22) Filed: Jul. 2, 2008

(30) Foreign Application Priority Data
Jul. 6, 2007 (DE) 102007031659.5

(51) Int. Cl. B41J 29/38; B41J 2/09

(52) U.S. Cl. 347/9; 347/77

(57) ABSTRACT

The invention relates to a method and an apparatus for the creation, particularly also for the deflection of ink droplets of different sizes, particularly in a print image of a continuously operating ink jet printer, a continuous cohesive ink jet being projected by a nozzle of a pressure chamber, in which a sequence of sequence of sound pulses (140, 142) impinges upon the cohesive ink jet (9) transversely of the distribution direction (100), and with each sound pulse (140, 142) a section (12) of the ink jet (9), which acts upon the sound pulse, is removed from the cohesive ink jet (9) and deflected from its original distribution direction (100), thus interrupting the original ink jet (9) and forming an ink jet in the original distribution direction (100) from the remaining sections (Sa, Sb), the respective lengths of which can be selected from the chronological interval between two consecutive sound pulses (140, 142).

The invention relates to a method of producing, particularly also for the deflection of ink droplets of different sizes, particularly within a print image of a continuously operating ink jet printer, a continuous cohesive ink jet being projected by a nozzle of a pressure chamber. The invention further relates to an apparatus for producing, particularly also for the deflection of ink droplets of varying sizes from a cohesive ink jet, particularly in a print image, comprising a pressure chamber having a nozzle for producing a continuous cohesive ink jet.

Continuous operating ink jet printers have been used commercially for applying marking to various products for many years. The current operating principle of these ink jet printers functions such that ink to be applied is delivered to a pressure chamber located within the actual print head from a reservoir via pumps at a superatmospheric pressure, the pressure chamber having a nozzle on the side facing the product to be printed.

The nozzle has an opening diameter within a range of, for example, 30 μm to 200 μm. The ink jet is initially projected by the nozzle as a continuous ink jet, however, which is inexpedient, since the characters thereby produced in this type of inscription are made up of individual dots, or individual ink droplets.

In order to separate the ink jet into individual uniform ink droplets, a modulator is attached to the pressure chamber to generate pressure deviations in the discharged ink jet so that it breaks apart after a short amount of time into individual uniform ink droplets at defined intervals after being projected by the nozzle. The size of the ink droplets depends on the modulation frequency applied, the nozzle diameter, and the pressure generated by the pump, and can be adjusted within the system's limitations from the combinations of the parameters stated. A variation of the droplet size of successive ink droplets is not possible.

Shortly before shearing the ink droplets off of the discharged ink jet, the ink droplets are each subjected to an individual electric charge, the size of the charge depending on the desired position of impingement onto the product to be inscribed. In order to ensure the electric charge the ink has a low electrical conductivity.

During the charging process the ink droplet is not yet separated from the ink jet projected by the nozzle of the ink jet printer so that free charge carriers moved back and forth to or from the charge electrode depending on the polarity and strength of the exterior charge voltage due to electrostatic induction, where the ink chamber, and thus the ink reservoir are, e.g. electrically maintained at ground potential. The charge electrode has no mechanical contact with the ink jet.

When the ink droplet separates from the ink jet while in the field range of the charge electrode, the electric charges migrated into the droplet due to the electrostatic induction remain in the droplet, and this also outwardly appears to be electrically charged after the separation process. If, for example, the charge electrode is positively charged, the negative free charge carriers in the ink migrate into the field when the ink jet enters into the electric field of the charge electrode, whereas the positively charged free charge carriers in the ink are forced out of the electric field.

In this manner a charge separation takes place directly before the separation of the droplet on the front edge of the ink jet, and the thus produced charge imbalance in the droplet separation remains intact, and in this example, the droplet is projected by the field of the charge electrode in a negatively charged manner.

Since the ink droplet separates as a droplet during the electrostatic induction time of the charge voltage as a matter of construction and principle, an amount of charge remains on the separated ink droplet as described, the amount of which corresponds to the level of the charge voltage applied with a constant electric is conductivity of the ink, and thus the amount of charge on each droplet can be changed with a change of the charge voltage.

Due to their initial linear flight, the electrically charged ink droplets subsequently enter the electrostatic field of the plate capacitor, and are deflected from their more or less linear flight depending on their individual charge, and after being projected by the electrostatic field, continue to fly at a certain angle to their original flight path that depends on their charge.

Using this principle, different positions of impingement on a surface to be inscribed with individual ink droplets selected, this being carried out in this embodiment in a deflection direction only. In order to exclude individual droplets from the print image, or if printing is not desired, the ink droplets are equipped with a certain fixed charge, or remain uncharged so that they enter a collection tube after being projected by the electrostatic field of the plate capacitor, where they are pumped back into the ink reservoir via a pump system. In this manner the not printed ink circulates in a cycle, which has lead to the designation of continuously operating ink jet printer.

A disadvantage of the conventional embodiment described is that due to the system-related type of deflection, the ink droplet of the ink itself must be electrically conductive, albeit only a little, so that the individual amount charge required for the electrostatic deflection can be applied to each individual ink droplet.

In this manner the amount of suitable inks is limited, since it is not possible or effective with every desired ink composition to make it itself or by means of additives electrically conductive. One example may be ink having magnetic properties. Such ink could be configured as electrically conductive by means of an additive, however, due to induction and the related additional varying deflection forces, the flight paths of the ink droplets cannot be controlled.

Contrary to this, DE 103 07 055 describes a method of deflecting ink droplets that variably deflects the ink droplets created in a customary manner via printing modulations in the ink by means of ultrasonic wave depending on the sound energy expended.

With this type of deflection it is advantageous that the inks to be printed no longer need to be electrically conductive, thus enabling the use of a large amount of different types of inks having various properties.

One disadvantage in the system described in DE 103 07 055 is that the droplets are created via the pressure chamber by means of a resonance process, thus having at least a same size at a certain frequency such that a print image having different line widths can be created only by means of overlapping multiple ink droplets, and thus can be created only in stages. Another disadvantage is that with the use of a simple sound generator the impinging sound energy not only acts upon the ink droplet exclusively, but also at least partially on the previous and subsequent flying droplets due to the size of the surface creating sound, thus limiting a precise deflection of the ink droplets.

The object of the invention is therefore to create a method and an apparatus making it possible to eliminate the disadvantages given above. The object of the invention is further to create a method and an apparatus making it possible to create different ink droplet sizes in an image to be printed, and to precisely deflect same into a desired flight direction.

The object is attained in that contrary to the known technique the creation of individual ink droplets from a continuous and cohesive ink jet after the ink jet is projected by the nozzle of the pressure chamber is done by directing a sequence of sound pulses upon the cohesive ink jet transversely of the distribution direction, and that with each sound pulse a section of the ink jet, which acts upon the sound pulse, is removed from the cohesive ink jet and deflected from its original distribution direction, thus interrupting the original ink jet and forming an ink jet in the original distribution direction from the remaining sections, the respective lengths of which can be selected from the chronological interval between two consecutive sound pulses.

The aim is further achieved by means of an apparatus of the type stated above, in which at least one sound generator is provided outside the pressure chamber and transversely offset from the ink jet, by means of which a sequence of sound pulses can be generated and directed at the cohesive ink jet transversely of the distribution direction, a section of the ink jet, on which the sound pulse acts upon, being removed from the cohesive ink jet and deflected from its original distribution direction with each sound pulse, the original ink jet being interrupted and formed into an ink jet from the remaining sections in the original distribution direction, the respective lengths of which depend on the chronological interval between two consecutive sound pulses.

The invention is based on the core principle that a cohesive ink jet can be selectively and preferably repeatedly interrupted by means of a sound pulse, preferably by means of a bundled ultrasonic impulse or hyper-sound impulse so that depending on the chronological interval of the sound interrupting pulses remaining ink jet sections of various sizes can be formed, which continue to move along their original flight path.

For this purpose the invention may provide that at least one sound generator is arranged transversely of the ink jet projected by the nozzle of the pressure chamber, preferably at a 90° angle, which is actuated by means of a suitable electric actuation via a superordinate controller, and emits particularly brief sound pulses lateral to the ink jet.

The invention may also provide the focusing of the generated sound pulses, or sequence of sound pulses, for example, in that a focusing unit is arranged for the sound pulses between a sound generator and the ink jet, by means of which the sound waves of the sound pulse emitted by each sound generator are focused into a respective focal point.

For this purpose, the invention may provide that the ink jet extends through the focal points such that the sound energy of the sound pulses can act upon the ink jet in the best possible manner.

If the still cohesive ink jet is then struck in the focal point of a first sound generator by at least one sound pulse, a certain section of the ink jet is removed by means of the energy transferred to the ink jet via the sound pulse and the associated sound impulse, thus interrupting the ink jet.

Since the removed portion of the ink jet is simultaneously subjected to a movement impulse transverse to the original flight path thereof across the sound impulse, the removed portion is thereby leaves the original flight path of the ink jet, and continues to fly off at a certain angle to the original flight path, and can thereby be collected by means of a collector, and transported back to the ink circulation.

The invention may provide that the remaining ink jet sections generated in this manner due to the dispersion of the originally cohesive ink jet may have any different, or the same length, depending on the chronological interval of the interrupted sound pulses. Along the further path these remaining sections are formed into ink drops of different size due to the inner cohesion forces of the ink depending on the length of the sections.

For this purpose it may be effective not to use all ink drops created in this manner for printing, and to guide the ink droplets not used into a collector provided for this purpose, from which they can, for example, be transported back into the ink circulation.

The invention may provide that the ink jet is divided into equally long remaining sections by means of a first sound pulse sequence at a certain frequency, which may each be divided into segment sections of different lengths by means of a second sound pulse. In this manner on or two ink droplets may be formed from the respective segment sections, one of which, for example, is provided for printing.

The other droplets can be collected by means of a suitable collector, and returned to the ink circulation. For this purpose it is simply possible to create ink droplets of various sizes for printing. The maximum size of an ink droplet created from such a section substantially depends on the length of the defined section.

The invention may further provide for the creation of droplet frequency and/or clock frequency necessary, for example for printing, for actuating sound generators by adjusting the frequency of the first sound pulse sequence, or by varying same to an outer predetermined frequency. Such an outer frequency can, for example, be provided by an external machine actuation, and may depend on the path speed of a production machine, for example.

The deflection of the ink droplets created in such a manner may occur according to the invention in a successive deflector, for example, in that the ink droplets provided for inscription are deflected in certain deflection directions by means of a second sound generator, in that a deflection impulse in impressed on it by means of at least one sound pulse transversely acting upon the droplet, which preferably acts perpendicular to its original movement impulse, and the ink droplet is deflected into a new movement direction that extends at an incline to the original distribution direction.

The invention may provide for the creation of the different sound pulses necessary due to the different droplet sizes created according to the invention in that the size and/or mass of the ink droplets to be deflected is continuously determined by means of a sensor mounted in front of the deflector, and to generate the sound pulses required for a certain deflection via the deflector by means of a superordinate controller.

This ensures that all ink droplets of various sizes provided for inscription, which are to be deflected into a certain deflection direction, can be selectively deflected by means of a respectively adjusted sound pulse. The sound pulses may differ with regard to their duration, their energy, their frequency spectrum, their impulse shape, or their focusing, etc, it also being possible to create a deflection of a droplet, for example, by means of multiple sound pulses.

Depending on the embodiment of the deflector it is possible that the possible flight paths of the deflected ink droplets are arrayed, for example, a fan shape, by means of which a printed line can be inscribed with a deflection into a transverse direction to the original flight path.

It is also possible, for example, by means of a certain number of successively arranged deflectors (sound generators), to deflect the ink droplets into multiple deflection directions extending parallel to each other, thus advantageously resulting in the height of a printed line created in such a manner being substantially independent of the distance of the material to be printed to the ink jet printhead.

Those ink droplets that are not used for a printed line to be created, and which accordingly are also not deflected by a sound field, can preferably be directed to the collection opening of a collection tube in a known manner and transported back to the ink circulation, for example, by means of a pump.

Any of the known methods for generating sound may be utilized as sound generators for creating individual ink droplets and/or their deflection, such as electrodynamic transducers, plasma sound generators, etc, according to the invention at least part of the pulsed sound waves generated by the sound generator being focused into a focal point.

For this purpose, for example, an acoustic lens, a reflector material, or a combination thereof can be utilized. According to the invention it is also possible to embody the sound generator, and particularly a sound-generating surface such that it acts, for example, as a Fourier transform of a substantially punctiform sound event. In this manner sound waves based from this surface can be bundled substantially into one or more focal points in reverse operation.

For this purpose the sound-generating surface is embodied as, for example, a Fresnel zone plate in a simple case, the sound-generating surface being divided into separate concentric regions that can be electrically actuated individually. It is therefore possible by means of a electric actuation of the respective regions to generate a desired sound pulse with regard to their respective amplitude, phase position, chronological sequence, and frequency spectrum, without any additional acoustic lenses or reflectors, and to bundle it into a focal point.

It is also possible with a embodiment of the sound-generating surface and a electric actuation of the respective regions to create multiple acoustic focal points that are independent of each other in order to, for example, divide the ink jet in a first focal point into sections, and individually deflect the ink droplets formed from the respective sections accordingly in a second subsequent focal point.

Illustrated embodiments of the invention and prior art are illustrated in the following figures. Therein:

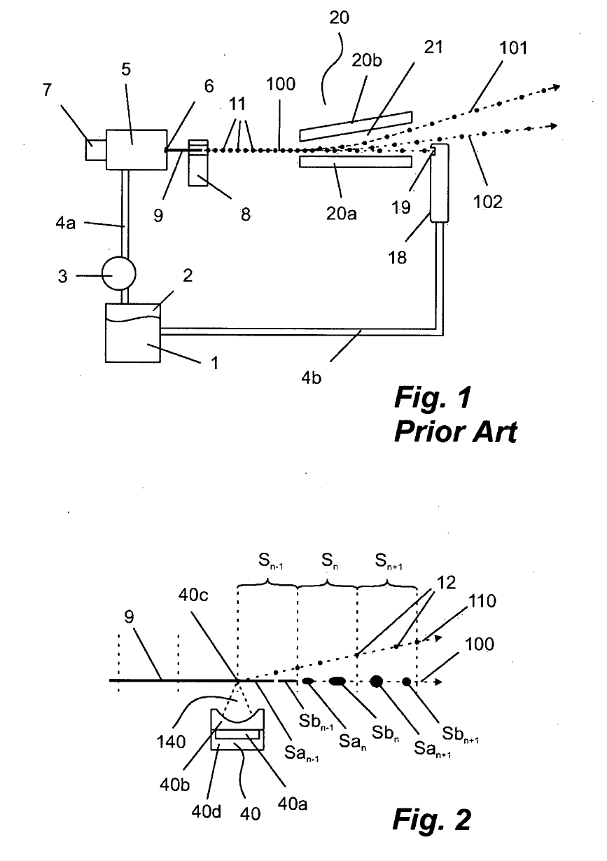

FIG. 1 shows an arrangement for creating ink droplets and their deflection according to the prior art;

FIG. 2 schematically shows the creation of ink droplets of different sizes by means of a sound-generating system;

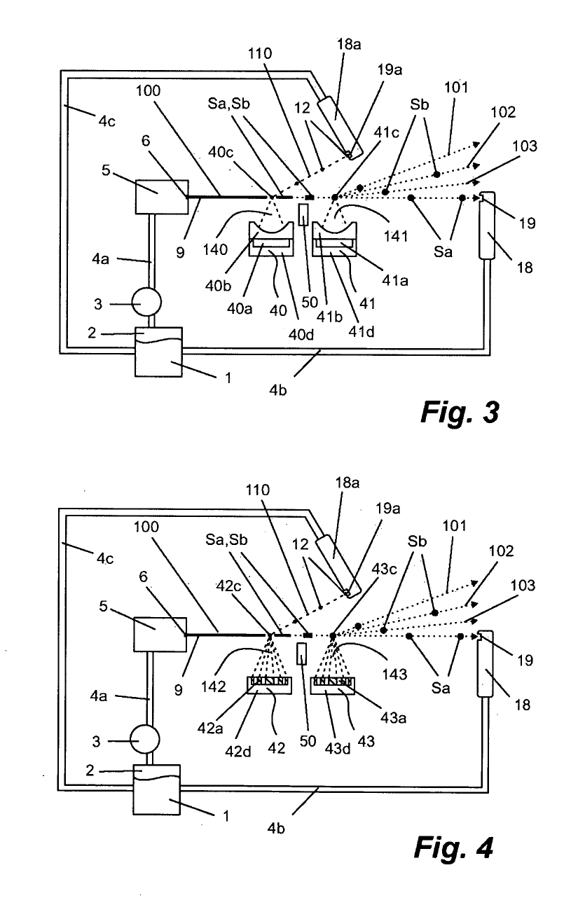

FIG. 3 shows a first embodiment according to the invention for the creation of ink droplets and their deflection;

FIG. 4 shows a second embodiment according to the invention for the creation of ink droplets and their deflection.

FIG. 1 shows as a comparison to the invention an example of a printhead of the known type of a continuously operating ink jet printer. The ink 1 is initially conveyed by a pump 3 from a storage container 2 via lines 41 into the pressure chamber 5 at the one end of which a nozzle 6 is attached. The pressure in the pressure chamber 5 is modulated via additional modulation units 7 attached to the pressure chamber such that the ink jet 9 projected by the nozzle 6 breaks apart into individual ink droplets 11 of substantially the same size within a short distance after being discharged. Shortly before breaking apart the individual ink droplets 11 are equipped with an individual electric charge via a charging electrode 8.

The ink droplets 11 now travel along their path 100 and enter an electric field 21 formed by electrodes 20a and 20b of a plate capacitor 20. Depending on the charge level and on the polarity of the charges on the ink droplets 11 and on the polarity and strength of the electric field 21 in the field space of the plate capacitor 20, the individual ink droplets are deflected in different directions 101, 102 that are illustrated as examples.

The entire amount of the possible deflection angles merely depends on the effect of the charging electrode, and is not limited in principle. The individual plates 20a and 20b of the plate capacitor 20 can be inclined relative to each other, as shown in FIG. 1. However, it is also possible to utilize plates that are parallel to each other without limiting the general principle.

The polarity and strength of the electric field 21 is effectively held substantially constant in this embodiment, since a change in field strength acts simultaneously upon a plurality of droplets that are in the field space of the plate capacitor at this time, thus making influence on an individual droplet impossible.

After being projected by the field space 21 of the plate capacitor 20, an electrostatic force no longer acts upon the ink droplets 11, and they remain on their new flight paths 101, 102. This results in a fan-shaped array of flight paths. Ink droplets 11, which are, for example, not charged or charged only slightly since they had to be eliminated from the print image, are subjected to, for example, no deflection, or only a small deflection in the electrostatic field 21 of the plate capacitor 20, and enter an opening 19 of a collection tube 18 for return of the ink. The ink collected in this manner is again guided into the ink container 2 via feed lines 4b, and thus returned to the ink cycle.

It is understood that this operational scheme functions only using electrically conductive inks, since otherwise imparting an electrostatic charge to the ink droplets would not be possible.

FIG. 2 shows a schematic illustration for the creation of ink droplets of different sizes. The continuous and cohesive ink jet 9 being projected by the nozzle 6 of a pressure chamber 5 along a distribution direction 100 passes through the focal point 42c of a first sound-generating arrangement 40 that comprises, for example, a holder 40d for a sound generator 40a and a focusing unit 40b provided in front of the sound generator 40a, the sound waves 140 generated by the sound generator 40a being bundled into a focal point 42c.

A sequence of sound impulses is generated by means of a master controller via the sound-generating arrangement 40 such that the ink jet 9 is interrupted, for example, in equal intervals, thus resulting in specific segments Sn−1, Sn, Sn+1, . . . .

Furthermore, second sound impulses may be generated, for example, during the pauses between the first ones at different times, thus resulting in the division of the respective segments Sn−1, Sn, Sn+1, . . . into two segment portions San−1, San, San+1, . . . and Sbn−1, Sbn, Sbn+1, . . . , the respective segments Sa and Sb having different lengths depending on the chronological sequence.

Due to the cohesion forces of the ink the different ink jet sections created in this manner are formed into droplets having a different droplet volume within a short amount of time, which move along the original distribution direction 100.

The ink proportions 12, which are removed upon the interruption of the ink jet 9, and are therefore subjected to a certain deflection impulse via the sound pulse, are deflected, for example, into a deflection direction 110, and are guided into, for example, a collection opening 19a of a collector 18a as illustrated in FIGS. 3 and 4, and can be transported back into the ink reservoir 2 via return lines 4c.

Due to the fact that each segment Sn−1, Sn, Sn+1, . . . can be divided in two ink droplets of different sizes by means of the second described sound pulses, it is further possible, for example, for printing, to merely use the droplets Sbn−1, Sbn, Sbn+1, . . . for printing, and to deflect it accordingly to create a printed line by means of a downstream deflector. The remaining ink droplets San−1, San, San+1, . . . are not deflected, and are guided, for example, into the collection opening 19 of a collector 18, and can be transported back to the ink reservoir 2 via return lines 4b.

In this manner it is possible to create for printing ink droplets Sb having different volumes, the minimum volume of an ink droplet intended for printing vanishing, and the maximum volume of an ink droplet intended for printing may be equal to all the volume in a segment Sn.

For this purpose FIG. 3 shows a schematic illustration of a first embodiment of an ink-jet printhead according to the invention for creating and deflecting ink droplets of an ink that is not necessarily electrically conductive, and particularly of an electrically non-conductive ink.

The ink 1 is pumped from a storage container 2 into a pressure chamber 5 by means of a pump 3 via feed lines 4a, a nozzle 6 being located on an end of the pressure chamber. Due to the substantially static pressure created in the pressure chamber 5 by the pump 3, the ink 1 is projected by the pressure chamber 5 via the nozzle 6 as a continuous and cohesive ink jet 9 along a distribution direction 100, and reaches the region of the sound-generating system 40 after a certain travel.

As described, the sound-generating system 40 comprises, for example, a sound generator 40a located in a fixture, having a focusing unit 40b on the side facing the ink jet 9. The spacing between the sound-generating system 40 and the ink jet 9, and particularly the embodiment of the focusing unit 40b are configured such that the focal point of the focusing unit 40b falls on the ink jet 9 moving along the distribution direction 100. In this manner the sound pulses 140 emitted by the sound generator 40a are concentrated on a small region on the ink jet 9 such that a certain sound energy and a certain sound impulse are transferred to a certain region of the ink jet 9, by means of which the continuous and cohesive ink jet 9 can be divided into certain sections Sn1, Sn, Sn+1, . . . , in that a certain ink portion is removed at the separation points.

Furthermore, second sound pulses may be generated, for example, during the pauses between the first sound pulses at different times, by means of which the segments Sn−a, Sn, Sn+1, . . . are divided into two segments San−1, San, San+1, . . . and Sbn−1, Sbn, Sbn+1, . . . , the different segments San−1, San, San+1, . . . and Sbn−1, Sbn, Sbn+1, . . . created in this manner continuing to move along the direction 100, and reaching, for example, the region of a sensor unit 50, by means of which, for example, the size and the position of center of gravity can be determined at least for an ink droplet intended for printing.

From the data determined in this manner the type of sound pulses required for a certain deflection can be determined in a master controller for a following droplet deflector 41, which also represents, for example, a deflector (sound generator) operating by means of sound pulses, and the sound generator 41a can be actuated accordingly.

For this purpose the deflector 41 comprises a sound generator 41a located in a receiver 41d, the sound waves 141 generated by means of a focusing unit 41b are bundled into a focal point 41c. The deflector 41 is directed crosswise to the distribution direction 100 of the ink droplets Sa, Sb such that the ink droplets Sa, Sb each pass through the focal point 41c, and can be deflected from their original direction 100 into a desired new direction 101, 102, 103 by means of sound pulses.

Any ink droplets not intended for printing are not deflected, and reach, for example, the collection opening 19 of a collector 18, and can be transported back into the ink reservoir 2 via a return line 4b. If, for example, only the ink droplets Sb created for printing are utilized, they are subjected to a respectively required movement impulse transverse to their original direction of movement 100 via a sound pulse acting upon them, depending on the size and desired deflection direction, whereas the ink droplets Sa are not subjected to any additional impulse, and reach the collection opening 19 along the direction 100. For this purpose it is possible to selectively deflect an ink droplet of a different size into the desired direction, and thus to create a print image on a substrate to be printed from individual printer dots of different sizes.

The ink portions removed with the separation of the ink jet 9 and the segments Sn−1, Sn, Sn+1, . . . are subjected to respective deflection impulses by means of the respective sound pulses, and are deflected into a deflection direction 110, and reach, for example, the collection opening 19a of a collector 18a, and can be transported back to the ink reservoir 1 via return lines 4c.

FIG. 4 illustrates a second embodiment according to the invention for the creation of ink droplets and their deflection, in which the sound-generating system 42 is embodied for the creation of ink droplets of different sizes such that it can be operated as a Fourier transform of a punctiform sound event.

In this manner it is possible to operate such a sound-generating system 42 without a focusing unit, since the sound waves 142 are bundled into a mutual focal point 42c with overlap of the respective amplitudes and phases, by means of which the ink jet 9 can be divided into individual segments Sn−1, Sn, Sn+1, . . . and into respective different segments San−1, San, San+1, . . . and Sbn−1, Sbn, Sbn+1 . . . a similar manner.

The deflection of the ink droplets having different sizes and created in this manner can be carried out in a similar manner by means of a downstream deflector 43 as described, this also being embodied as a Fourier transform at least of a punctiform sound event. By using “Fourier transform” sound generators, it is further possible to carry along the focal point 42c, 43c along the direction 100, for example by means of a change of the phase positions and/or of the amplitudes and/or of the frequency spectra of the sound-generating segments 42a to each other, at least for the duration of the sound pulse, for example, for improving the transfer effect of the sound energy onto the ink jet 9, or onto the ink droplets to be deflected.

It should be noted with regard to all embodiments that the technical characteristics described with reference to one embodiment can be utilized not only in that specific embodiment, but also in the other embodiments. All technical characteristics disclosed in this description of the invention are to be classified as substantial to the invention, and may be arbitrarily utilized in combination or alone.

1. A method of producing, particularly also for the deflection of ink droplets of different sizes, particularly in a print image of a continuously operating ink jet printer, a continuous cohesive ink jet being projected by a nozzle of a pressure chamber wherein a sequence of sound pulses impinges upon the cohesive ink jet transversely of the distribution direction, and with each sound pulse a section of the ink jet, which acts upon the sound pulse, is removed from the cohesive ink jet and deflected from its original distribution direction, thus interrupting the original ink jet and forming an ink jet in the original distribution direction from the remaining sections, the respective lengths of which can be selected from the chronological interval between two consecutive sound pulses.

2. The method according to claim 1 wherein the remaining sections are formed into ink droplets during flight by means of cohesion forces, the volume of which depends on the length of a section.

3. The method according to claim 1 wherein the sections removed with division of the ink jet reach a collector and are transported back to the ink circulation.

4. The method according to claim 1 wherein remaining sections of a physically equal or at least similar length are formed by a sequence of chronologically equidistant sound pulses.

5. The method according to claim 1 wherein a remaining section, or a droplet already formed from same, is deflected from its original distribution direction by means of a sound pulse acting transversely upon same.

6. The method according to claim 1 wherein a further sound pulse sequence overlaps a sequence of chronologically equidistant sound pulses, by means of which the sections that are of the same, or at least similar length, and are created by means of the chronologically equidistant sound pulses are divided into at least two, particularly different partial sections/droplets, wherein at least one of the partial sections/droplets is deflected from its distribution direction by a further subsequent sound pulse, and forms a droplet having a volume depending on the partial section/droplet, particularly in order to contribute to a print image, and the non-deflected partial section/droplet is collected.

7. The method according to claim 1 wherein a sound pulse is generated for the deflection of a section contributing to the print image, or of a droplet already formed of them, with regard to its properties, particularly energy and/or impulse and/or frequency and/or focusing, dependent on the droplet/section, particularly the size or mass thereof, which is to act upon the sound pulse.

8. The method according to claim 7 wherein the size/volume and/or the center of gravity of the mass of a section/droplet is determined by means of a sensor, which is provided in front of a sound generator for generating this sound pulse.

9. The method according to claim 1 wherein the section or a droplet already formed by the section, which contributes to the print image, can be selectively deflected in various directions by means of at least one sound pulse acting upon them that is positioned transverse to the distribution direction of the section or the droplet already formed by them, which contributes to the print image.

10. The method according to claim 1 wherein the generation of a sound pulse is carried out using at least one sound generator, which is arranged outside the pressure chamber and along the distribution direction.

11. The method according to claim 1 wherein a sound pulse is focused upon the cohesive ink jet.

12. The method according to claim 11 wherein a sound pulse is focused upon a section of the cohesive ink jet, or upon the ink droplet created, by means of a focusser.

13. The method according to claim 1 wherein the sound pulses are generated by means of at least one electrodynamic, electrostatic, magnetodynamic, magnetostatic, or piezoelectric transducer.

14. The method according to claim 1 wherein the sound pulses are generated by means of a sound generator, the form and/or arrangement of sound-generating elements of which corresponds to the Fourier transform of a substantially punctiform sound pulse at a distance to the ink jet such that a sound pulse is generated by means of an actuation of the sound generator, which is focused on the ink jet without employing any additional focusing elements.

15. The method according to claim 1 wherein the focus of the sound pulses is carried along with the movement of the ink jet during its duration.

16. The method according to claim 1 wherein the strength of the deflection of a section, or droplet, depends and/or is controlled by the energy and/or the impulse and/or the focusing of a sound pulse.

17. An apparatus for producing, particularly also for the deflection of ink droplets of different sizes from a cohesive ink jet, particularly in a print image, comprising a pressure chamber having a nozzle for creating a continuously discharged cohesive ink jet wherein at least one sound generator is arranged outside the pressure chamber and transversely of the ink jet, by means of which a sequence of sound pulses can be generated that impinge upon the cohesive ink jet transversely of the distribution direction, wherein a section of the ink jet, on which the sound pulse acts can be removed from the cohesive ink jet and deflected from its original distribution direction with each sound pulse, wherein the original ink jet can be interrupted and formed into an ink jet from the remaining sections in the original distribution direction, the respective lengths of which depends on the chronological interval between two consecutive sound pulses.

18. The apparatus according to claim 17 wherein ink droplets can be selectively deflected in different directions using at least one sound generator extending in the distribution direction from the ink jet comprising the remaining sections.

19. The apparatus according to claim 17 wherein the sections of the ink jet removed for the interruption reach a collector, and are transported back to the ink circulation.

20. The apparatus according to claim 17 wherein a sound generator is embodied as an electrodynamic and/or electrostatic and/or magnetodynamic and/or magnetostatic and/or piezoelectric transducer.

21. The apparatus according to claim 17 wherein it comprises a focusing unit for focusing the at least one sound pulse onto a section of the cohesive ink jet or droplet.

22. The apparatus according to claim 17 wherein the sound generator has a shape and/or arrangement of sound-generating elements, which corresponds to the Fourier transform of a substantially punctiform sound pulse at a distance to the ink jet such that a sound pulse can be generated by means of an actuation of the sound generator, which can be focused on the ink jet or a droplet without employing additional focusing elements.

23. The apparatus according to claim 22 wherein the focal point can be carried along with the movement of the ink jet or a droplet during the duration of the sound pulse.

24. The apparatus according to claim 17 wherein it comprises a sensor, which is arranged particularly between a first and a second sound generator, by means of which the size and/or the center of gravity of the mass of a section or of an ink droplet formed by them, contributing to a print image, can be determined.

25. The apparatus according to claim 17 wherein the ink droplets can be selectively deflected in different directions by means of at least one sound pulse, which is produced by a generator arranged transversely of the distribution direction of the ink droplets.

26. The apparatus according to claim 17 wherein the different sound pulses required for the creation of a certain deflection direction for different ink droplets can be created by a master controller, depending on the size and/or mass of the ink droplets.
